(19) United States
(12) Patent Application Publication
(10) Pub. No.: US 2007/0068117 A1
(43) Pub. Date: Mar. 29, 2007

(54) Device for screwing caps onto containers

(76) Inventors: Horst Lang, Barbing/Auburg (DE); Martina Wrede, Kehlheim/Grundelshausen (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/581,232

(22) PCT Filed: Dec. 1, 2004
(86) PCT No.: PCT/EP04/13599

§ 371 Date: Dec. 11, 2006

(30) Foreign Application Priority Data
Dec. 2, 2003 (DE) 10356222.2

(51) Int. Cl. B65B 7/28; B67B 1/06

(52) U.S. Cl. 53/331.5

(57) ABSTRACT

A device for screwing caps onto containers with several closing heads revolving on a closed track, each closing head having a controllable gripping tong, a control unit for the opening position and the closed position of the corresponding gripping tong, with each control unit revolving along with and allocated to every gripping tong. The revolving control units can be reversed in direction between the opening position and the closed position by stationary stops. In this manner, a precise and rapid reversal of the gripping tongs, as well as a simple adjustment of the opening- and closed position, is made possible without a stationary control curve.

### CROSS-REFERENCE TO RELATED APPLICATION

This is the U.S. national stage under 35 U.S.C. §371, of international application no. PCT/EP2004/013599, having an international filing date of Dec. 1, 2004, and claims priority to German application no. 103 56 222.2 filed on Dec. 2, 2003.

### FIELD OF THE DISCLOSURE

The disclosure relates to a device for screwing caps onto containers, such as used in bottling operations.

### BACKGROUND OF THE DISCLOSURE

Such a device is already known, in which the activation of the gripping tongs for the closures is carried out by means of a stationary control curve in which curve rollers revolving on a circular track engage with the gripping tongs (SU-PS 1 736 915). Because of the maximum permissible gradient of the curve, the time for the closing- and opening movement of the gripping tongs is thereby relatively great, which stands in the way of high capacities. A change of the closing- or opening position of the gripping tongs, as the case may be, requires a time-consuming replacement of the control curve. In addition, the manufacturing and assembly of the control curve is very cost-intensive, because its course must be precisely adjusted to the course of a second control curve, which defines the lifting movement of the closing heads.

### SUMMARY OF THE DISCLOSURE

The task which forms the basis for the disclosure lies in creating a device for screwing caps onto containers in which it is possible to control the gripping tongs without a stationary lifting curve, and which makes possible a rapid and variable reversal of the gripping tongs.

In one device in accordance with the disclosure, a precise and rapid reversal of the gripping tongs is carried out—entirely without a stationary control curve—by means of control units revolving with the closing heads in connection with the stationary stops. The stops themselves can easily be reversed, and can also be easily accommodated in sterile rooms.

One particularly simple and reliable reversal is brought about if, in accordance with one additional development of the disclosure, the closed position and/or the open position of the control units is stabilized in a self-limiting manner.

Various possibilities are conceivable for the construction of the control units.

### BRIEF DESCRIPTION OF THE DRAWINGS

Two examples of implementation of the disclosure are described in the following by means of the diagrams. These depict the following:

FIG. 1: A lateral view of a closing head with the gripping tong opened, in a partial cross-section;

FIG. 2: A partial lateral view of a closing head in accordance with FIG. 1, with the gripping tong closed;

FIG. 3: A partial lateral view of a closing head with a modified control unit, with the gripping tong closed;

FIG. 4: A vertical section through the closing head in accordance with FIG.

FIG. 5: A view from above of the closing head in accordance with FIG. 1;

FIG. 6: A view from above of an additional design of a device for screwing on caps;

FIG. 7: The section A-B in accordance with FIG. 6.

### DETAILED DESCRIPTION OF THE DISCLOSURE

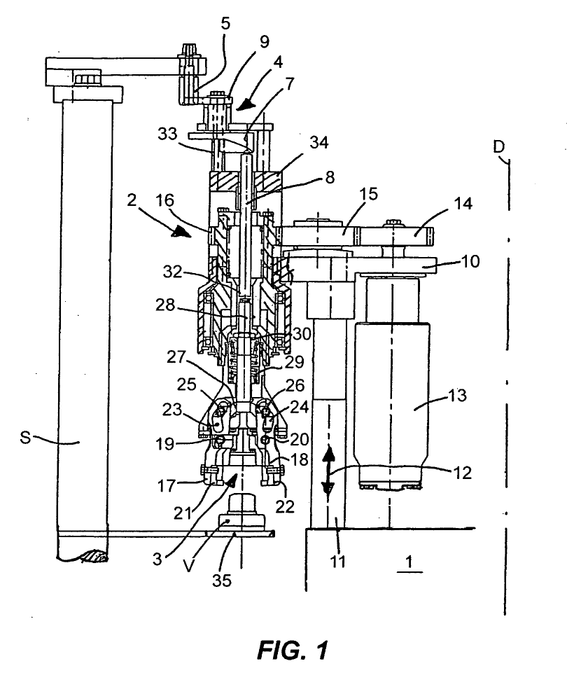

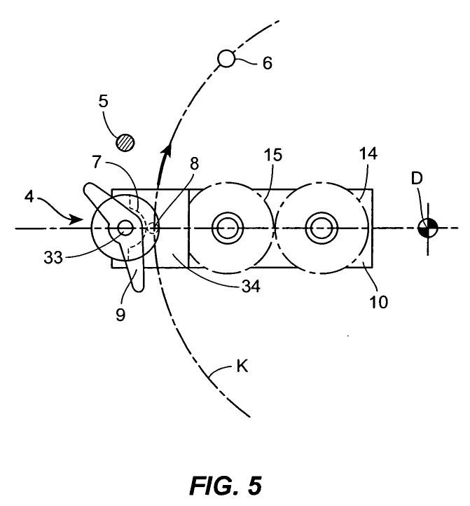

The device in accordance with the FIGS. 1, 2 and 5 is designed for the screwing of sealing caps (V) of plastic, which are provided with an internal threading, onto containers (G), in the form of PET bottles for beverages. It has a rotor (1) revolving around a vertical rotational axis (D), on which rotor several closing heads (2) are positioned distributed uniformly over the circumference, which heads revolve on a circular track (K).

Every closing head (2) is supported in a rotatable manner in a horizontal bearing bracket (10), which bearing bracket is, for its part, attached to a vertical column (11). This is accommodated in the rotor (1) in a controlled, height-adjustable manner by means of a lifting curve, not depicted, as indicated by the double arrow (12). An electrical servomotor (13) is additionally attached to the bearing bracket (10); this servomotor sets the closing head (2) into rotation by means of toothed wheels (14, 15, 16) at predetermined areas of its circular track (K), with the rotor (1) having a predetermined rotational speed and a predetermined torque.

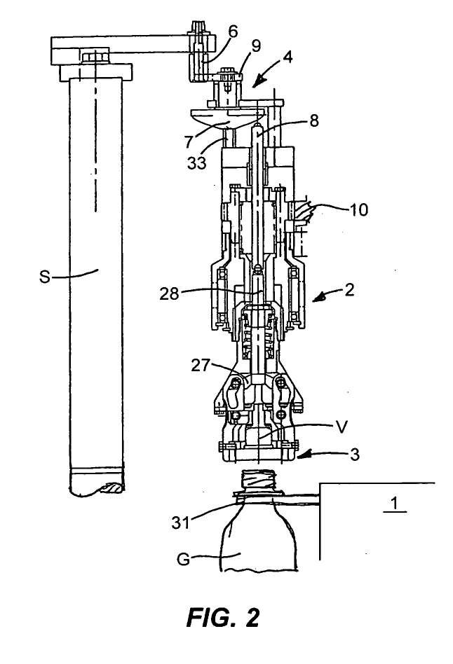

Each closing head (2) has, on its lower end, a gripping tong (3) for each cap (V), which is constructed of several, particularly three, gripping arms (17, 18) which are similar to double levers. The gripping arms (17, 18) can be swiveled around horizontal axes (19, 20), and are provided on the lower end with gripping jaws (21, 22) for a cap (V). On the upper end, the gripping arms (17, 18) have curve-shaped oblong holes (23, 24) with which bolts (25, 26) engage. These are attached to a control head (27) which is supported in the closing head (2) in a height-adjustable manner by means of a bar (28). A compression spring (29) which is supported on the lower end directly on the closing head (2), and on the upper end on a sleeve bushing (30) attached to the bar (28), is positioned on the vertical bar (28). The compression spring (29) thus pushes the control head (27) into its upper end position, which is depicted in FIG. 2, in which the bolts (25, 26) close the gripping tong (3), or keep it closed by means of the oblong holes (23, 24). A cap (V) is thereby solidly clamped between the gripping jaws (21, 22), so that it can be screwed onto a container (G) by means of the closing head (2), which is driven by means of the servomotor (13). For this purpose, a container holder (31) is attached to the rotor (1) underneath every closing head (2), in which holder the container (G) is clamped in a non-rotating manner.

Concentrically to the bar (28), a push rod (8) is supported in the closing head (2) in a height-adjustable manner. This is supported by means of a ball bearing (32) on the bar (28), so that a rotational movement relative to this is possible. Towards the top, the push rod (8) projects a small distance out of the closing head (2). In this area, a control unit (4) for the gripping tong (3) acting on the push rod (8), in the form of a cam (7), is supported rotatably on a vertical axis (33). The axis (33) is displaced laterally to the push rod (8), which is likewise positioned vertically, and is attached to a U-shaped support block (34), which block, for its part, is attached to the upper side of the bearing bracket (10). The control unit (4) thus participates in both the height movement of the bearing bracket (10), and thereby of the closing head (2), as well as in the rotational movement of the same on the circular track (K) around the rotational axis (D).

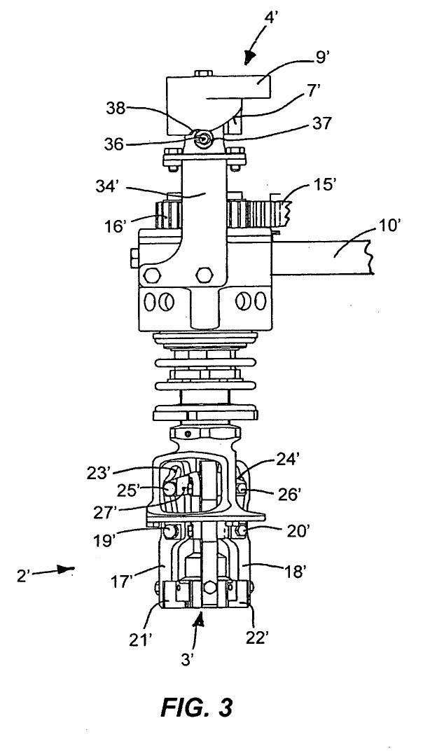

The cam (7) of the control unit (4) is constructed as a spatial curve and is formed in such a manner that, in the opening position depicted in FIG. 3, it presses the push rod (8) and, by this means, the bar (28), into its lower end position. As has already been described, the gripping tong (3) is thereby opened or held open, as the case may be, and can thus be lowered onto a cap (V) which is to be grasped. The caps (V) are distributed under the closing heads (2) in the usual manner by means of a supply unit (35).

In addition, the cam (7) of the control unit (4) is formed in such a manner that, in the closed position depicted in FIG. 2, it releases push rod (8), so that the bar (28) can, under the influence of the compression spring (29), occupy its upper end position. By this means, as has already been described, the gripping tong (3) is closed or held closed, as the case may be, so that a cap (V) grasped by the gripping tong (3) can be screwed onto a container (G).

The opening position of the control unit (4) is displaced by approx. 90 degrees relative to the closed position. Both positions are stabilized in a self-limiting manner by means of the bearing friction on the axis (33) (closed position) and by means of the friction between the cam (7) and the push rod (8), which is caused by the compression spring (29) (opening position).

Each control unit (4) additionally has an angle lever (9) on the upper end, which lever is non-rotatably connected with its cam (7). This cooperates with two bolt-shaped stops (5, 6), which are stationarily positioned on the columns (S) on the circular track (K) of the closing heads (2). The first stop (5) reverses the direction of the gripping tong (3) from the opening position depicted in FIG. 1 into the closed position depicted in FIG. 2, shortly after this has been placed onto a cap (V). The second stop (6) reverses the gripping tong out of the closed position depicted in FIG. 2 and into the opening position depicted in FIG. 1, shortly after the cap (V) has been completely screwed onto the container (G). The second stop (6) is depicted in FIG. (5) in dotted lines because it is, in fact, located at a greater distance from the first stop (5).

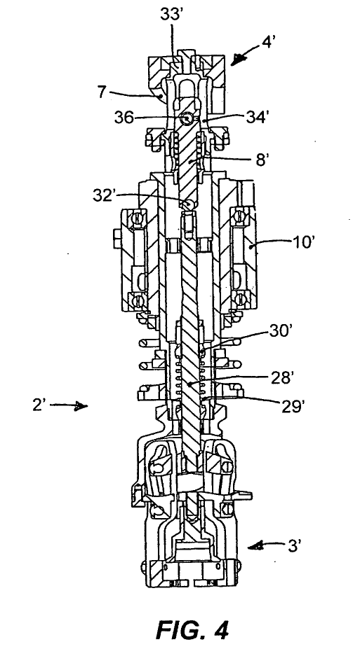

The closing head (2′) in accordance with FIGS. 3 and 4, with the exception of the control unit (4′), corresponds most completely with the closing head (2) in accordance with FIGS. 1 and 2. Corresponding parts are marked with the same reference figures and the supplemental mark (′). Only deviations are described in the following.

In the closing head (2′), the control unit (4′) is supported rotatably on its axis (33′), concentrically to the push rod (8′). The push rod (8′) supports a horizontal bolt (36) on its upper end, which bolt projects out of the push rod (8′) on both sides. One roller (37) each, which cooperates with the cam (7′) of the control unit (4′), is non-rotatably supported on the ends of the bolt (36) that project out. Through this fact, better friction conditions result than with direct contact between the push rod (8) and the cam (7) of the closing head (2). Furthermore, a better self-inhibition is possible through the fact that slight depressions (38) are incorporated into the cam (7′), into which depressions the rollers (37) are pressed under the influence of the compression spring (29′). The bolt (36) is guided into oblong holes of the support block (34′), and thus does not participate in the rotation of the closing head (2′).

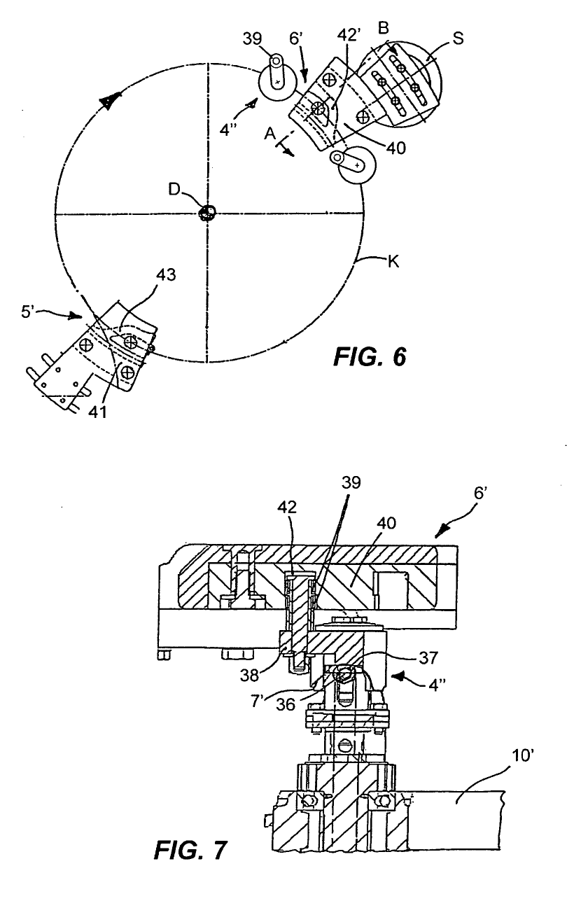

The device in accordance with FIG. 6 and 7 only differs from the device in accordance with FIG. 3 and 4 through the configuration of the control unit (4″) and the stationary stops cooperating with the same (5′ and 6′). The control unit (4″) here has a horizontal lever (38), on the upper side of which two concentric curve rollers (39) are positioned in a rotatable manner with a vertical rotational axis.

The stationary stops (5′ and 6′) for the opening or closing of the gripping tong (3), as the case may be, each have one horizontal plate (40, 41) here, on the lower sides of which slot curves (42, 43) are formed. The slot curves (42, 43) each have starting- and ending areas proceeding tangentially to the circular track (K), as well as a middle area proceeding obliquely to the circular track (K). The tangential areas make possible an intake and release of the curve rollers (39) free of impact, while the oblique middle area brings about the rotation of the lever (38), and thereby of the control unit (4″), by approx. 85°.

By this means, an abrasion-free and smooth course of the reversal of the gripping tongs (3) is brought about, even at high outputs. The slot curves (42, 43) only extend over a small portion of the circular track (K), and are positioned on the column (S) in such a manner that they can be adjusted independently of one another. Favorable manufacturing costs, as well as a simple adjustment to the operating conditions, result from this.

We claim:

1. A device for screwing sealing caps (V) onto containers (G), comprising several closing heads (2) revolving on a closed track, each closing head (2) having a gripping tong (3) which can be moved on and off in a controlled manner, each gripping tong (3) having a control unit (4) allocated thereto and to revolve therewith, each control unit movable relative to the closed track (K) between an opening position opening the gripping tong (3) and a closed position closing the gripping tong (3), and the control units (4) being operable to change direction by stationary stops (5, 6) between the opening position and the closed position.

2. A device in accordance with claim 1, wherein one of or both the closed position and the opening position of the control units (4) is stabilized in a self-limiting manner.

3. A device in accordance with claim 1, wherein or the control unit (4) has a cam (7) rotatably supported on the rotor (1), which cam is supported displaceably in the closing head (2) by of a push rod (8) which activates the corresponding gripping tong (3).

4. A device in accordance with claim 3, wherein every control unit (4) has an angle lever (9) non-rotatably connected with the cam (7), which lever cooperates with the stationary stops (5, 6).

5. A device in accordance with claim 3, wherein the rotational axis of the cam (7) and the longitudinal axis of the push rod (8) are positioned in parallel with the rotational axis (D) of the rotor (1), and the can (7) is constructed as a spatial curve.

6. A device in accordance with claim 1, wherein the stationary stops (5′, 6′) have curved parts (42, 43) proceeding obliquely to the closed track (K) of the closing heads (2).

7. A device in accordance with claim 6, wherein the control units (4) are provided with rollers (39) which scan the curved parts (42, 43).
